(19) United States
(12) Patent Application Publication
(10) Pub. No.: US 2002/0140678 A1
(43) Pub. Date: Oct. 3, 2002

(54) Mouse

(76) Inventors: Makoto Kawashima, Tochigi (JP); Kouichi Kuroiwa, Tochigi (JP)

Correspondence Address: McGuire Woods, Suite 1800, 1750 Tysons Boulevard, McLean, VA, 22102-3915, US

(21) Appl. No.: 09/987,030

(22) Filed: Nov. 13, 2001

(30) Foreign Application Priority Data
Mar. 28, 2001 (JP) P.2001-093005

(51) Int. Cl. G09G 5/08

(52) U.S. Cl. 345/166

(57) ABSTRACT

A mouse body is formed with a first slot from which a first storage medium is inserted or ejected, and a second slot from which a second storage medium is inserted or ejected. A board member is provided within the body. A first interface is formed on a first main face of the board member to communicate data with the first storage medium. A second interface is formed on a second main face of the board member to communicate data with the second storage medium.

### BACKGROUND OF THE INVENTION

The present invention relates to a mouse to be an input device for a computer, and more particularly to a mouse comprising an interface for connecting two kinds of storage media to a computer.

In recent years, small-sized flash memory cards such as so-called compact flashes, smart media or memory sticks have spread as storage media for storing various data to be used in electronic apparatuses with the spread of the electronic apparatuses such as digital cameras. By using the memory cards, image data picked up by the digital camera can be transferred to a computer and can be edited on the computer.

However, many computers do not currently comprise such an interface as to directly access the memory cards. In order to use the memory card by a computer having no means for accessing the memory card, therefore, it has been necessary to add an interface apparatus for connecting the memory card to the computer.

For such an interface apparatus, for example, there has been known an adapter to be attached to a PC card slot of a computer. When the adapter is used, however, the slot of the computer is occupied. Moreover, in the case in which an insertion unit of the memory card is provided on the outside of the computer, a place where the insertion unit is to be provided should be newly held around the computer. In the case of an external insertion unit, furthermore, it is necessary to connect a cable to the adapter. Consequently, the number of cables provided around the computer is increased. Thus, the cables can be neither put in order nor handled simply, which is a drawback for a user.

Moreover, there are plural kinds of memory cards having physically different shapes. For this reason, in the case in which the memory card is varied depending on each electronic apparatus, the user should prepare an interface for each memory card.

### SUMMARY OF THE INVENTION

The invention has been made in consideration of the problems described above, and has an object to provide a mouse comprising an interface section capable of connecting two kinds of storage media to a computer.

In order to achieve the above object, according to the present invention, there is provided a mouse, comprising:

a body formed with a first slot from which a first storage medium is inserted or ejected, and a second slot from which a second storage medium is inserted or ejected;

a board member provided within the body;

a first interface formed on a first main face of the board member, which communicates data with the first storage medium; and

a second interface formed on a second main face of the board member, which communicates data with the second storage medium.

In this configuration, two kinds of storage media having different physical shapes can be connected to a computer without using a dedicated interface devices.

Moreover, since the mouse also serves as an interface device, it is not necessary to newly provide a dedicated interface around the computer. Thus, a space can be reduced around the computer.

Examples of the storage medium include so-called memory sticks, SD (secure digital) cards, multimedia cards (MMC) and smart media. Depending on the way for selecting the interfaces to be provided on the board member, the storage medium can be applied to any combination. In the preferred embodiment as described below, the case of a combination of the memory stick and the SD card will be described.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1A is a vertical section view showing a mouse according to one embodiment of the invention;

FIG. 1B is a horizontal section view showing the mouse;

FIG. 2 is a view showing the external appearance of the mouse;

FIG. 3A is a schematic plan view of a printed circuit board provided in the mouse, showing a side on which an interface for a memory stick is provided; and

FIG. 3B is a schematic plan view of the printed circuit board, showing a side on which an interface for an SD card is provided.

### DETAILED DESCRIPTION OF THE PREFERRED EMBODIMENTS

A mouse according to one embodiment of the invention will be described below in detail with reference to the accompanying drawings. In this specification, for convenience of the description, when the mouse is put on a desk in a state of normal use, the right side, the left side, the side away from an operator and the side close to the operator are defined as “right side”, “left side”, “front side” and “rear side”.

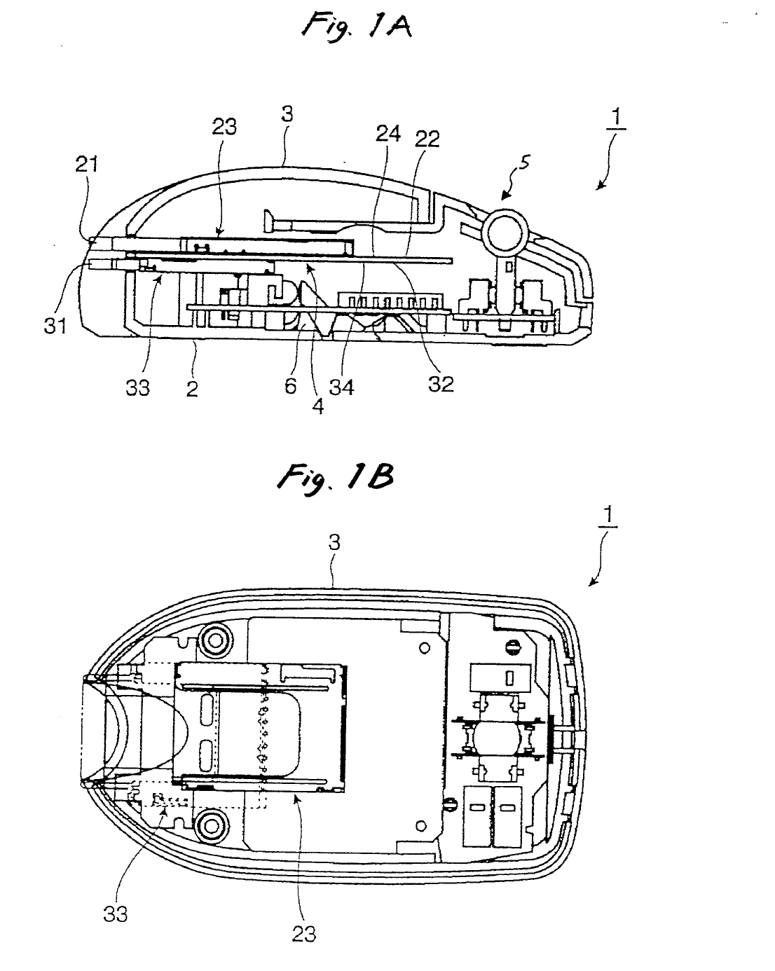

As shown in FIGS. 1A, 1B and 2, a mouse 1 comprises a case body 2 in which essential elements of the mouse are provided, and a cover member 3 having a shape corresponding to the case body 2. Moreover, the mouse 1 comprises an input information processor for processing information input to the mouse 1 through a mouse operation, a data processor for processing data transmitted from a memory card, and an information processor provided with a hub, a memory or the like for relaying signals communicated between the input information processor and a computer, the data processor and the computer.

As the essential elements of the mouse 1, the case body 2 is provided with, for example, a printed circuit board 4, an input section 5, a motion detector 6, a connecting section (not shown), and an information processor (not shown).

The cover member 3 is provided with a memory stick slot 21 and an SD card slot 31 in a rear part of the mouse 1, from which a memory stick 20 (a first storage medium) and an SD card 30 (a second storage medium) are inserted or ejected, respectively.

The printed circuit board 4 has a first interface section 22 provided on one main face for carrying out data communication with the memory stick 20 and a second interface section 32 provided on the other main face for carrying out data communication with the SD card 30.

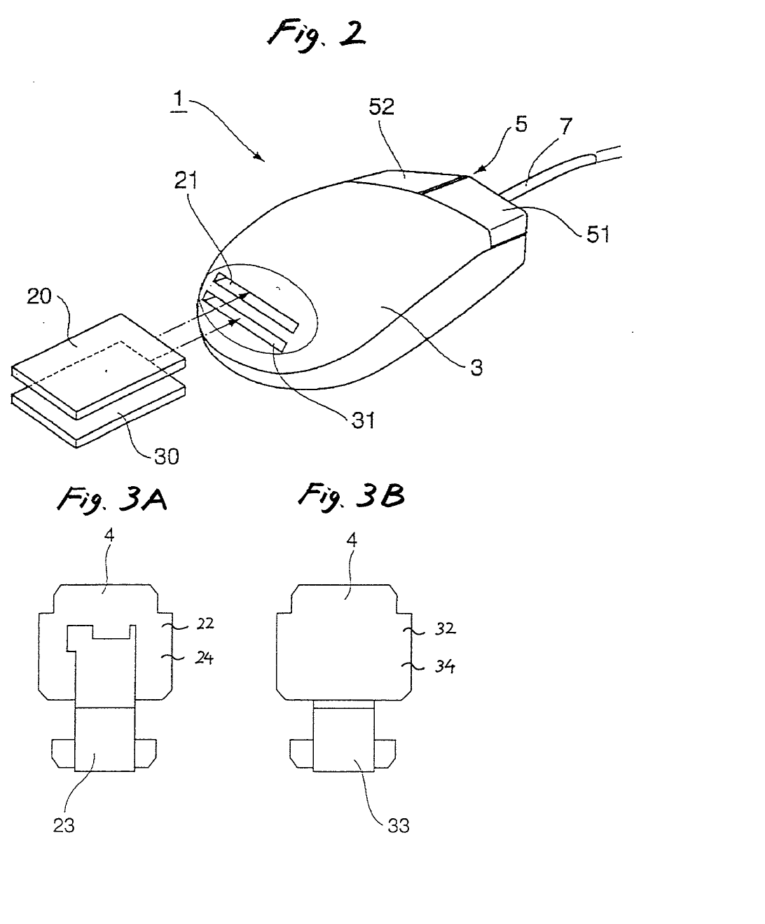

The first interface section 22 has a memory stick connector 23 for receiving the memory stick 20 to be electrically connected and a memory stick data processor 24 for communicating data with the memory stick 20 (see FIG. 3A). Moreover, the second interface section 32 has an SD card connector 33 for receiving the SD card 30 to be electrically connected and an SD card data processor 34 for communicating data with the SD card 30 (see FIG. 3B).

The memory stick connector 23 is provided in such a position as to correspond to the memory stick slot 21 of the cover member 3, and the SD card connector 33 is provided in such a position as to correspond to the SD card slot 31 of the cover member 3. To prevent the user from inserting the SD card inversely up side down, the SD card connector 31 is of a reverse type such that the user can insert the SD card in a state that an obverse face thereof directs upward.

The input section 5 has two input buttons, that is, a right side click button 51 and a left side click button 52 such that an operation signal can be input from the user to a computer through the mouse. Moreover, the input section 5 may have an operation wheel for easily carrying out the scroll operation of a screen.

A motion detector 6 adopts an optical detection method in which one feature point on a face on a desk through a CCD sensor and detecting the direction of the motion of the mouse based on the motion of the feature point when the mouse itself is moved over the desk. The mouse 1 requires a space for inserting two kinds of storage media. In consideration of the fact that a track ball occupies a large space of the case body 2, therefore, the optical motion detector using no track ball is advantageously employed in that a size can be more reduced.

The connecting section is provided in front of the mouse 1 and is connected to the computer through a connection cable 7 by a USB (Universal Serial Bus) connecting method. More specifically, the mouse 1 can communicate data with the computer by a data transfer method corresponding to the USB. Therefore, high versatility of the mouse 1 can be attained. Moreover, if the mouse 1 corresponds to the USB, convenience is also improved in that the data communication speed is high, and the connection to the computer can be carried out while the computer is activated.

Accordingly, the mouse 1 serves as an ordinary mouse and an communication interface for the memory card. Therefore, the mouse 1 can be connected to the computer and can be used in the same manner as the ordinary mouse, and furthermore, the memory stick 20 and the SD card 30 are inserted into the mouse 1 so that data can be communicated between the computer and the memory cards, for example.

According to this configuration, data of each memory card can be communicated without newly providing an interface device for connecting the memory card to the computer to which the mouse 1 is connected.

The mouse according to the invention is not limited to the embodiment described above. In addition to the combination of memory cards as described above, combinations of a memory stick and a multimedia card, a memory stick and a smart media, and an SD card and a smart media can be proposed for a storage medium which can be used. In this case, various combinations can be applied by selecting the interface section of the storage medium provided on both main faces of the printed circuit board 4 depending on the type of the storage medium.

Moreover, the motion detector is of a track ball type having a track ball exposed partially from a bottom face of the case body, an X direction detecting mechanism for detecting a rotation component in one direction (X direction) of the track ball with respect to the plane on the desk and a Y direction detecting mechanism for detecting a rotation component in a perpendicular direction (Y direction) to the one direction.

The input section may have one input button (click button), and furthermore, may have an operation wheel for easily carrying out the scroll operation of a screen.

Moreover, the connecting section may be connected to the computer through a connection cable in conformity with a serial data transfer method such as PS/2 or RS-232C in addition to the USB. Furthermore, the connecting section may communicate data through a data transfer method other than the serial data transfer method, for example, a parallel data transfer method such as Centronics, SCSI or IDE. Alternatively, the connecting section may transfer data to the computer by wireless using infrared rays.

In any case, the mouse 1 can be connected to the computer and can be used in the same manner as an ordinary mouse, and furthermore, can communicate data between the computer and the storage medium. Accordingly, data of each memory card can be communicated without newly providing an interface device for connecting the storage medium and the computer to which the mouse 1 is connected.

What is claimed is:

1. A mouse, comprising:
a body formed with a first slot from which a first storage medium is inserted or ejected, and a second slot from which a second storage medium is inserted or ejected;
a board member provided within the body;
a first interface formed on a first main face of the board member, which communicates data with the first storage medium; and
a second interface formed on a second main face of the board member, which communicates data with the second storage medium.

2. The mouse as set forth in claim 1, further comprising an optical detector provided within the body, which optically detects a motion of the mouse.

3. The mouse as set forth in claim 1, wherein the first storage medium and the second storage medium have different physical shapes.

4. The mouse as set forth in claim 1, wherein the first storage medium is a memory stick and the second storage medium is an SD card.

5. The mouse as set forth in claim 3, wherein the second interface includes a connector for receiving the SD card in a state that an obverse face of the SD card directs upward.

6. The mouse as set forth in claim 1, further comprising a connecting section through which a computer is connected based on an USB format.
